(19) United States
(12) Patent Application Publication
(10) Pub. No.: US 2004/0250067 A1
(43) Pub. Date: Dec. 9, 2004

(54) Method and device for securing communications in a computer network

(76) Inventor: Fabien Felix, Nice (FR)

Correspondence Address: YOUNG & THOMPSON, 745 SOUTH 23RD STREET, 2ND FLOOR, ARLINGTON, VA, 22202, US

(21) Appl. No.: 10/482,025

(22) PCT Filed: Jun. 24, 2002
(86) PCT No.: PCT/FR02/02171

(30) Foreign Application Priority Data
Jun. 27, 2001 (FR) 01/08451

(51) Int. Cl. H04L 9/00

(52) U.S. Cl. 713/168

(57) ABSTRACT

The invention relates to a security method for a computer system comprising a server part (1), which is equipped with at least one server (3), and a client part (2) which is provided with at least one client terminal (4) by means of which a client can access the system by specifying a session name. The invention also relates to a device for using said method. According to the invention, the following steps are carried out: creation of a gateway device (5) in the server part (1), said gateway device communicating with the server (3); creation of a proximity device (6) in the physical vicinity of each client terminal (4), said proximity device communicating with the client terminal (4) and the gateway device (5); communication between the server (3) and the client terminal (4) by means of gateway (5) and proximity (6) interface devices; encryption of all or part of the transmission between the gateway device (5) and the proximity interface device (6). The invention can be used to secure electronic communications, particularly in accordance with communication protocol TN 3270.

The present invention relates to a process as well as a device for securing communications in a computer system.

Such a system generally comprises a server portion provided with at least one central server and a client portion provided with at least one client terminal generally remote from the server portion and connected to the latter by a communication network.

Clients such as remote employees of the central computer system, can access the system by the client terminals. They identify themselves generally by a session name associated with them.

The invention will be particularly applicable for securing computer transmissions using the communication protocol TN 3270.

This protocol is used by a large part of the computers corresponding to the system called SNA (Systems Network Architecture). The SNA protocol defines how the program of the central server exchanges information with the client device. The SNA protocol moreover describes messages which are used for screen formats (such as controls to regulate the position of the pointer or the screen color) defined in the form of a data flow to the 3270 format.

The client machine which receives the 3270 data flow interprets and generates the proper screen format according to a set of predetermined rules.

The communication protocol SNA was generally available to specific new protocols (such as X25) but not to the higher level protocols such as TCP/IP (Transmission Control Protocol/Internet Protocol) which permits many systems with non-homogeneous platforms to communicate with each other.

For the purpose of carrying out transfers of 3270 data flow on a TCP/IP network, the Internet community has defined a protocol called TN 3270E which is defined in the following documents: Request for Comment (RFC) 1576, 1647 and 2355.

The initials TN of the protocol mean Tel Net, the Tel Net protocol being particularly defined in the following documents: Request for Comment (RFC) 854, 860 and 862.

The digital extension 3270 means the format of the data flow and the addition E means Extended as defined in the document Request for Comment (RFC) 1647.

In the description that follows, there is meant by TN 3270 not only the notion of the TN 3270 protocol but also its extension TN 3270E, given that the general principle of embodiment is exactly the same for the two protocols.

In the present state of the art, only a limited security which is unreliable is provided for computer communications using architecture such as defined above with a combination of the TN 3270 protocol through a public computer network of the Internet type.

At present, there is attributed only one session name to a client, this session name being associated with properties stored in a configuration table of the server but which has various drawbacks.

In the first place, the session name of the client is transmitted in the clear through the network. It is thus possible to pirate it.

Worse, the properties associated with the session name can comprise the IP address of the client terminal (address of the locality associated with a computer terminal in an Internet network according to the Internet protocol). As a result, if the client changes the IP address (for example if he connects to another point on the network), the server cannot recognize and permit access to the computer system.

In short, it will be seen that the present authorization means used in the framework of these systems were satisfactory for a private network but are not compatible with use in a public network of the Internet type. Thus, this type of application requires being able dynamically to modify certain parameters of connection and particularly the IP address of the client.

The present invention permits overcoming the drawbacks of the techniques known at present and provides, to do this, a process and device that are particularly advantageous.

One of the first objects of the invention is to use a complete digital certificate permitting effective authentication of each client.

This creation of a digital certificate takes place in a particularly secure fashion at the client's terminal.

Moreover, there can be associated with the digital certificate a secure transmission of the data from the client terminal to the server.

These advantages as to the security both of the authorization of access of the clients and of the transmissions through the communication network, are produced whilst providing a totally transparent implantation for the pre-existing components of the computer system. In particular, the present invention can be installed in the form of extensions to the existing systems without at the same time requiring software or material modification of the latter that could give rise to numerous practical drawbacks.

This done, the present invention enlarges the applications in particular of the TN 3270 protocol because it permits using the conventional Internet network instead of limiting its use to specific private networks.

Other objects and advantages will become apparent from the description which follows, which gives in detail a preferred embodiment of the invention but which is however not limiting.

The present invention relates to a process of securing communications in a computer system comprising a server portion provided with at least one server and a client portion provided with at least one client terminal by which a client can access the system by specifying a session name, characterized by the following steps:

creation of a gateway device in the server portion, in communication with the server,

creation, in the physical vicinity of each client terminal, of a proximity device in communication with said client terminal and the gateway device,

communication between the server and the client terminal by means of proximity and gateway interface devices,

encryption of all or a part of the transmission between the gateway device and the proximity interface device.

This process could have the following modifications introduced as follows:

there is memorized in the client terminal and the proximity interface device a certificate of authorization associated with a single client session name,

the certificate is presented to the server from the proximity interface device, by means of the gateway device, for verification of the authorization of the connection to the client,

the certificate includes the session name of the client,

the certificate is memorized in the client terminal and the proximity interface device by:

providing to an installer a certificate identifier and a session name provided by the server during creation of the session at the client terminal for a certification organism,

installation of the certificate on the client terminal by teleloading the certification organism on request of the installer, conditioned on the presentation of the certificate identification and by therein integrating the client session name by taking the installer,

encryption of the data between the gateway device and the proximity interface device takes place by use of pairs of public and private keys,

there is used a proximity interface device in the form of software extension implemented in the client terminal,

the client takes his session name at the client terminal during the initial configuration of the application of the client terminal,

there is verified the identity of the session name taken and of the one included in the certificate to verify the authorization of the client,

the communication protocol Tenlet 3270 is used,

the communications in the system take place by a standard TCP/IP network.

The invention also relates to a computer system with secured communication comprising a server portion provided with at least one server and a client portion provided with at least one client terminal by which a client can access the system by taking a session name, adapted to practice the process according to the invention, characterized by the fact

that it comprises:

a gateway server in the server portion, in communication with the server,

a proximity interface device in physical proximity to each client terminal, in communication with said client terminal and the gateway device,

encryption means for transmissions between the gateway device and the proximity interface device.

According to a modification, the transmission messages between the gateway device and the proximity interface device comprise a header integrating the security data.

The accompanying drawings are given by way of example and are not limiting of the invention. They show only one embodiment of the invention and permit it to be easily understood.

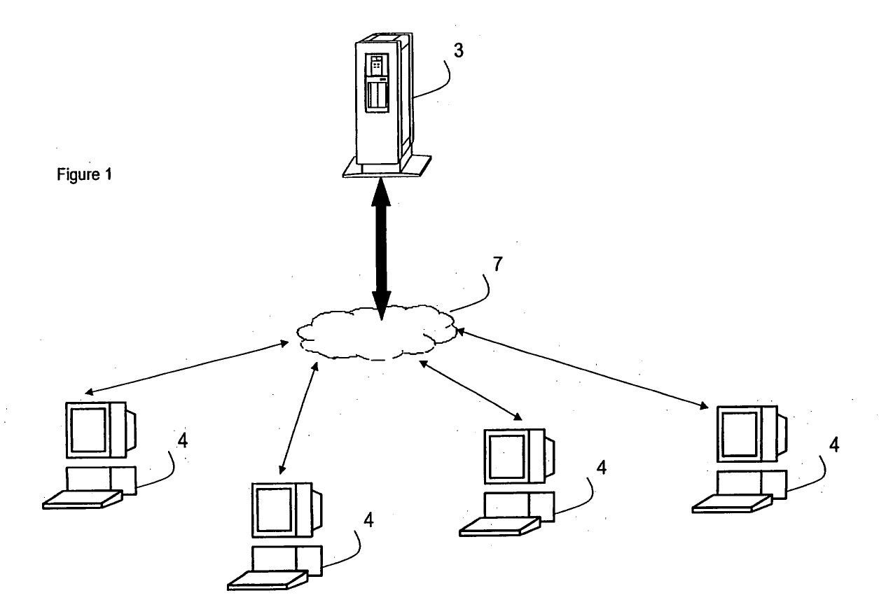

FIG. 1 is a general illustration of the architecture of a computer system using a network for communication between client terminals and a central server.

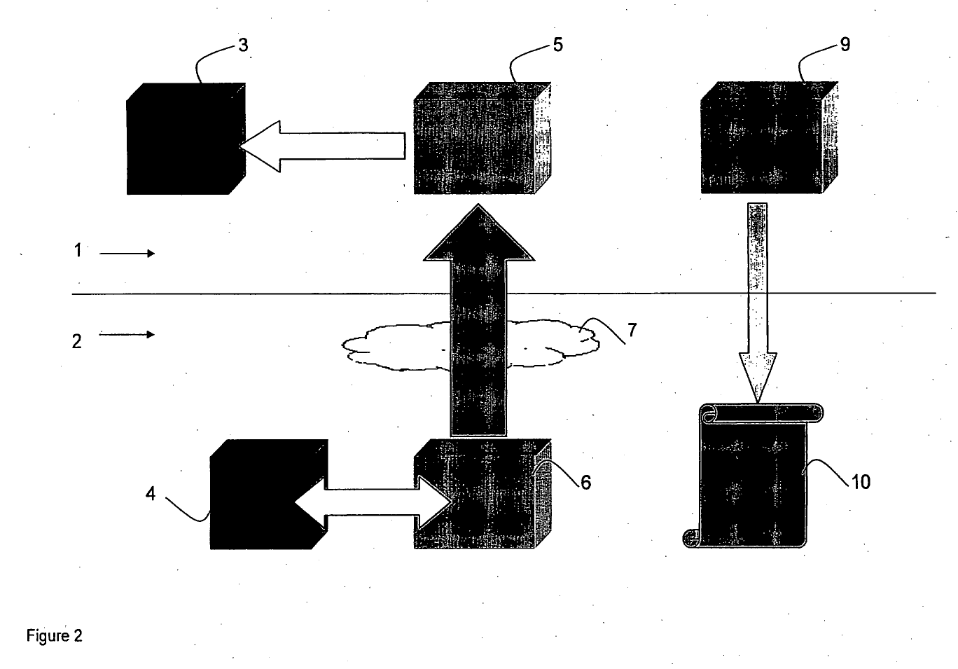

FIG. 2 is a schematic presentation of the invention.

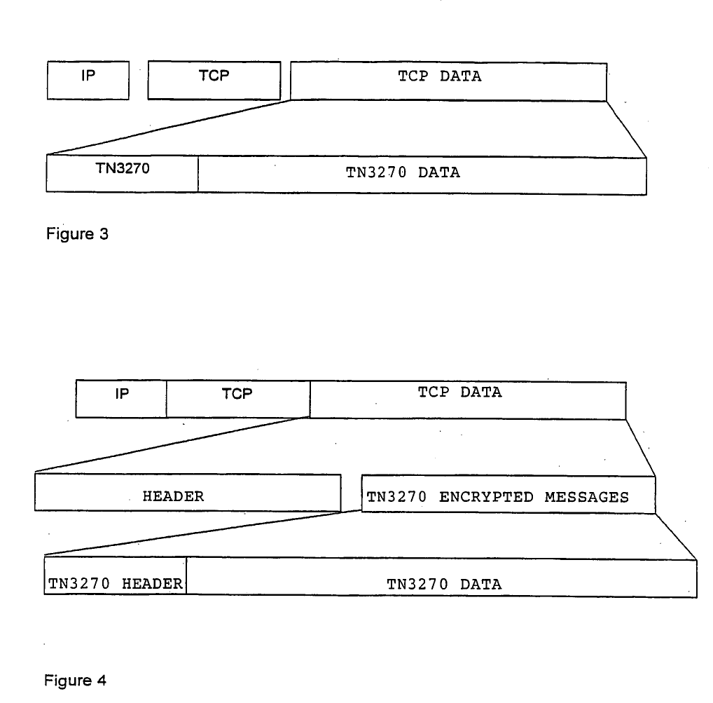

FIG. 3 shows a conventional message format using the TN 3270 protocol via a TCP/IP network.

FIG. 4 shows a message format characteristic of the invention.

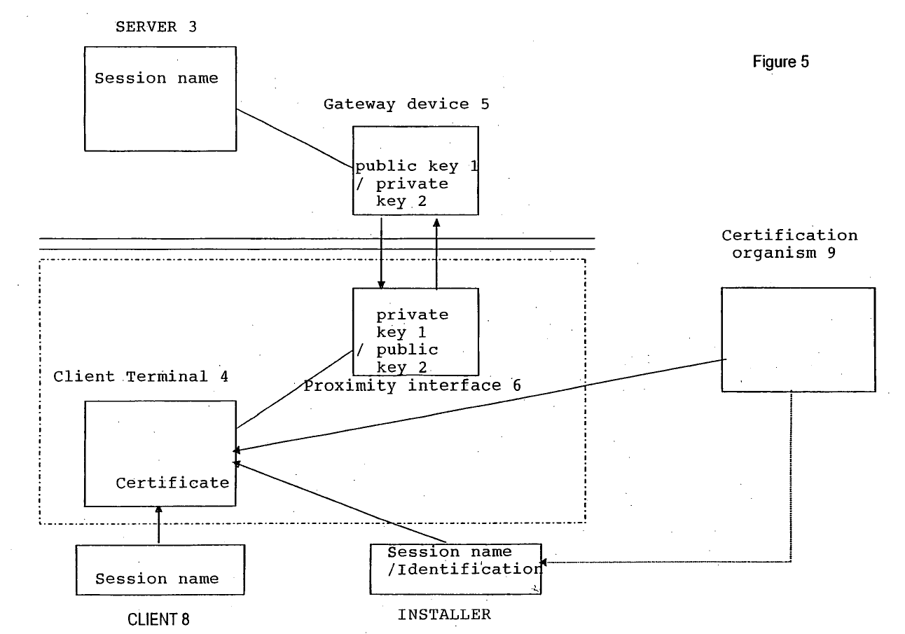

FIG. 5 shows more precisely the interactions between the constituent elements of the system using the invention.

The description which follows gives a preferred embodiment of the invention in the framework of the use of communications according to the TN 3270 protocol in a TCP/IP communication network. This preferred embodiment however is not limiting of the applications of the invention.

FIG. 1 gives an illustration of the architecture of the TN 3270 format network as known at present. Such an architecture comprises a plurality of client terminals 4 communicating via a network 7 with a server 3.

FIG. 2 shows an embodiment of the invention and its characteristic components.

There is first of all created, in the server portion 1, a gateway device 5 preferably in the form of a software extension of the server 3. This software extension however does not change the integrity of the configuration of the server 3.

The gateway device 5 acts as an intermediary between the plurality of client terminals 4 and the server 3 during their communication via the network 7.

On the one hand, the gateway device 5 manages several simultaneous TCP/IP sessions with programs supported by the client terminals 4 and, on the other hand, several simultaneous sessions with the server 3.

According to the invention, there is also created a proximity interface device 6 positioned in the client portion, adjacent each of the client terminals 4. In particular, the proximity interface device 6 could be implanted in the form of a software extension of the client terminal 4. This extension would still preserve the software integrity of the client terminal 4.

Given that, during a complete creation of the architecture of the network, it is possible to make specific the source code of the TN 3270 client software 4 to integrate therein the functionalities of the proximity interface device 6 so as to provide a single unitary program.

The proximity interface device 6 acts as an intermediary between the client terminals 4 and the gateway device 5. As a result, the combination of the gateway device 5 and the proximity interface device 6 acts as a true intermediate assembly for communication via the network 7.

This combination permits securing the communications via the network 7 and, beforehand, to verify the authorization of the clients.

There will hereafter be described more precisely these operations.

To permit the certain identification of the clients, recourse can preferably be had to the service of a certification organism 9 such as schematically shown in FIG. 2.

In a manner known per se, the organism 9 is constituted by an Internet site to which access can be had to teleload and install a certificate on each client terminal 4 using the invention. Access is had to the service of the organism 9 a single time for each client terminal 4, during installation of the software application of the client.

The essential object of the certificate created by the organism 10 is to block a session name TN 3270 which could be used by the client. A digital certificate is an ideal solution to store identification information because the navigation systems on the Internet generally provide mechanisms which permit protecting the certificates against copying from one computer to another.

The present invention uses other functions of the certificates and particularly the keys used to encrypt and decode the data exchanged between the gateway device 5 and the proximity interface device 6.

Moreover, the certificate has a predetermined lifetime which renders it valid for a given period of time and which can be revoked at any time in a centralized manner.

The digital certificate 10 created according to the invention is in fact a data for attaching an electronic message used for purposes of security. In a known manner, the digital certificates are used to verify that the person sending the messages is in fact the one indicated to be and to supply to the person who receives the message the means for sending a coded response.

A person desirous of sending encrypted messages interrogates a certification organism as to the attribution of a digital certificate or thus implements himself the service by declaring himself to be the authority for the certificate.

The certification organism 9 is a confidential third party, such as a professional enterprise for this type of services, which delivers digital certificates to create digital signatures and pairs of public and private keys. The role of the certification organism 9, in the process according to the invention, is to guarantee that the client having a unique certificate is really the one he says he is. Generally speaking this means that the certification organism 9 has agreements with financial institutions such as a credit company, which gives to it information to confirm the identity of each individual.

The certification organism 9 delivers an encrypted digital certificate containing various identification information of the client as well as a public key. The certification organism 9 establishes its own public key accessible by any communication means and particularly by its Internet site.

The person receiving an encrypted message recovers and uses the public key of the certification organism 9 to decode the digital certificate attached to the encrypted message. He thus verifies that the certificate has in fact been delivered by the certification organism 9 and obtains the public key of the sender of the message as well as identification information contained in the certificate. With this information, the person receiving the message can thus send an encrypted response.

The present invention preferably uses this system of public keys for encrypting and decoding transmissions. In this context, two keys are necessary to permit the parties to exchange information in a secured manner: a public key and a private key. An example of embodiment is shown in FIG. 5 for the use of such pairs of public and private keys.

One of the keys of the pair is used to encrypt the message (the public key) whilst the other is used for decoding it (the private key). When the proximity interface device 6 wishes to address an encrypted message to the gateway device 5, it encodes it by using the public key and, the gateway device 5 being the only possessor of the corresponding private key of the pair, is the only device that can decode it.

Although the public and private keys of a pair will be mathematically correlated, in practice it is impossible to deduce one from the other. As a result, the public character of one of the keys does not endanger the security of encryption.

There could be particularly used for the production of the certificate 10 according to the invention the format widely used for digital certificates according to the ITU-T X.509 standard.

This format comprises the following fields: version, series number, identifying signature algorithms, name of the supplier of the certificate, period of validity, name of the user, information as to the public key of the user, unique identification of the provider, unique identification of the user, extensions, signature on the preceding fields. The certificate is signed by the provider to authenticate the relation existing between the name of the user and the public key of the user.

The present invention uses a free field of text in this certificate. Thus, the “name of the user” field is used to store the session name of the client which can be used on the client terminal which has teleloaded it.

For the sake of security, the certification organism 9 marks the certificate 10 as non-transferable, namely that it cannot be reinstalled on another client terminal once the installation step has been carried out.

The certification organism 9, which can also be the company practicing the invention, uses software which can turn on a WEB computer server or on a specific server. It has the duty of accessing a table of correspondence which will connect the TN 3270 session names with a certificate identification. Each time a new session name of a client is allotted on the server 3 for a new client, a new entry is added to the table of correspondence by the administrators of the system. The certification identification is a unique random number for each session name.

There will be described hereafter the steps of installation of the certificate at a client terminal 4 in a preferred embodiment.

In the first instance, the certificate identification as well as the session name are addressed to the person in charge of installing the certificate 10 in the client terminal 4. It will be remembered that preferably the client terminal 4 receives software means also necessary to the operation of the proximity interface device. A single material implantation of the certificate 10 will thus be effective both for the client terminal 4 as to its general function and for the proximity interface device 6.

The installer, thus knowing the identification of the certificate and name of the session, is connected to the client terminal 4 at the certification organism 9 by the Internet network. This latter interrogates the installer to take the certificate identification. The installer carries out this request and the identification of the certificate is returned to the certification organism 9 which will verify in the table of correspondence, which session name is connected to this identification. The certification organism 9 will then address a WEB page to the client terminal 4 permitting it to install the certificate including the correct session name in the field “user name” of the certificate 10.

FIG. 5 shows the interactions existing between the installer, the client station 4 and the certification organism 9.

Once the installation of the certificate 10 has been successfully performed, the service of the certification organism 9 is no longer used by the client.

As indicated above, the proximity interface device is preferably installed at the client terminal 4 and turns in parallel with the client application.

The device 6 authenticates the client during his entry into the session by authorizing the negotiation of the session name only for the session name installed at the client terminal 4, particularly according to the mentioned certification procedure 10.

Moreover, the proximity interface device 6 encrypts the data which are exchanged with the server 3 by means of the gateway device 5.

Thus, the proximity interface device 6 in the form of software acts as a TCP/IP client for the gateway device 5 and as a local TCP/IP server to accept or refuse the connection of a client.

The client application TN 3270 4 between a connection with the proximity interface device 6 and itself, is connected to the gateway device 5.

Thanks to the invention, the application program TN 3270 executed at the client terminal 4 can remain the standard initial program used by the client until then.

There will be described hereafter the steps of establishing the communication for a client via the server 3, until these two entities are ready to exchange data.

In the first instance, the client terminal is connected to the proximity interface device 6.

The proximity interface device 6 accepts the connection of the client and connects itself to the gateway device 5.

When the gateway device 5 accepts the connection of the proximity interface device 6, it begins an internal security process which depends on the implementation carried out during installation. By way of preferred example, it is possible at this time to present the certificate 10 to the server 3 to verify its validity. This certificate presentation message preferably has the specific format described further on with respect to FIG. 4. If the certificate 10 is not valid, the gateway device 5 rejects the connection and immediately disconnects the proximity interface device 6.

Use at this level of the certificate 10 as a digital key is very advantageous because the gateway device 5 can use several criteria for the verification of the authorization of connection, namely:

the authority which has delivered the certificate (certification organism 9) must be valid (to avoid persons up to no good to create a false certificate containing the good session name but not signed by the certification authority),

the date of validity of the certificate 10 must not have expired,

the certificate 10 must not have been revoked (if the server 3 manages a blacklist of revoked certificates, even if the user has a valid session name, he will not be connected).

A message of the condition of the certificate (indicating whether the certificate presented is valid) is returned to the proximity interface device 6 preferably with the message format described farther on in relation to FIG. 4.

If the gateway device 5 has validated the certificate 10, it connects to the server 3 in the manner of a conventional client terminal 4 according to the prior art.

If the server 3 accepts this connection, it starts a protocol negotiation by sending a data flow to the gateway device 5.

This latter encrypts the data flow and sends it to the proximity interface device 6 (preferably in the form of a message of the “encrypted data” type, whose format is described later with respect to FIG. 4. The gateway device 5 and the proximity device 6 use this format thereafter) which decodes it and addresses the data to the client terminal 4 by using a previously established connection.

At this time, the client terminal 4 has received the initial message from the server 3. It can respond thereto.

The proximity interface device 6 receives this response message and encrypts it to then send it to the gateway device 5 which decodes it and sends it in turn to the server 3.

The server 3 analyzes this response and interrogates the client for supplemental information, namely the type of material which he desires to use as well as the session name.

As before, this supplemental request is transmitted by the gateway device 5 then by the proximity interface device 6 with an encryption step and decoding step. The request of the server 3 is finally received by the client terminal 4.

The client terminal 4 responds to this message by sending again a message to the proximity interface device 6 responding to the interrogation of the server 3, by mentioning the type of machine and the session name which the client has taken.

The proximity interface device 6 detects that the response message contains the request for use of a session name of a specific client. From this fact, for purposes of control, it is verified at this time that the specific session name configured in the TN 3270 client application corresponds with the one present in certificates 10 installed at the client terminal 4.

If the session name appears in a certificate 10, the client is authorized to pursue the communication and the proximity interface device passes to the following step.

If the session name does not correspond to any valid certificate 10, the proximity interface device 6 rejects the request of the client.

It also closes the connections established with the client terminal 4 and the gateway device 5. Consecutively, the gateway device 5 closes the TCP/IP session established for this client with the server 3.

Instead of abandoning all of this process, the proximity interface device 6 can also change the invalid session name into a session name which it protects by a valid certificate 10, and continues the communication.

When this verification of session name and its consequences are carried out, the proximity interface device 6 encrypts the response message from the client by using the public key of the gateway device 5 and sends it to this latter. The gateway device 5 decodes the message with its private key and sends it in its turn to the server 3.

These steps of use of the public key and the private key are shown particularly in FIG. 5.

At this time, the server 3 receives the session name which must be used for the client who connects himself and can associate therewith the proper operational configuration.

The following negotiation steps, according to the TN 3270 protocol, can be pursued by using the same transmission method.

Preferably, upon each communication, the proximity interface device 6 and the gateway device 5 act as encryption and decoding elements and as routers between the clients and the server 3.

As to the format of the transmissions between the proximity interface device 6 and the gateway device 5, FIG. 3 shows a general example of the format of the messages according to the prior art, by using the TN 3270 protocol in a TCP/IP communication network.

FIG. 4 shows a characteristic format of the message practiced according to the invention. Thus, the TCP data presented in the message are, according to this characteristic, decomposed in a header and in an encrypted TN 3270 message portion.

The header in question depends on the type of message sent and particularly the step of exchange during initiation of the connection to the server as previously described.

In particular, the security data will be preferably transmitted to the level of this header. Thus, the header can be present in the format defined hereafter successively for sending the message of presentation of the certificate 10 from the proximity interface device 6 to the gateway device 5, the consecutive message of the condition of the certificate addressed from the gateway device 5 toward the proximity interface device 6, then for messages of the type comprising encrypted data.

| | Offset 1 | 1 | 2 . . . 5 | 6 | 7 . . . n |
|---|---|---|---|---|---|
| | Signature | Signature | Size of | Type | Data functions |
| | of the | of the | the | of | of the |
| | message | message | message | message | security type |
| Presentation | 0X00 | 0X00 | size | 0X13 | certificate |
| of | | | | | |
| certificate | | | | | |
| Condition of | 0X00 | 0X00 | size | 0X13 | response |
| certificate | | | | | code |
| Encrypted | 0X00 | 0X00 | size | 0X02 | encrypted |
| data | | | | | TN 3270 |
| | | | | | data |

The use of the specific header in the format of messages transmitted between devices 5 and 6, ensures the secure communication both during the negotiation phase for authorization and during the ultimate phase of data transmission.

### REFERENCES

1. Server portion

2. Client portion

3. Server

4. Client terminal

5. Gateway device

6. Proximity interface device

7. Network

8. Client

9. Certification organism

10. Certificate

1. Process for securing communications in a computer system comprising a server portion (1) provided with at least one server (3) and a client portion (2) provided with at least one client terminal (4) by which a client (8) can access the system by specifying a session name, characterized by the following steps
creation of a gateway device (5) in the server portion (1), in communication with the server (3),
creation, in physical proximity to each client terminal (4), of a proximity device (6) in communication with said client terminal (4) and the gateway device (5),
communication between the server (3) and the client terminal (4) by means of proximity interface devices (6) and gateway devices (5),
encryption of all or a portion of the transmission between the gateway device (5) and the proximity interface device (6).

2. Process according to claim 1 characterized by the fact
that there is memorized in the client terminal (4) and the proximity interface device (6) a certificate (10) of authorization associated with a single client session name,
that the certificate (10) is presented to the server (3) from the proximity interface device (6), by means of the gateway device (5), to verify the authorization of connection of the client (8).

3. Process according to claim 2 characterized by the fact
that the certificate (10) includes the session name of the client (8).

4. Process according to claim 3 characterized by the fact
that the certificate (10) is memorized in the client terminal (4) and the proximity interface device (6) by:
providing to an installer a certificate identification and a session name provided by the server during creation of the session at the client terminal (4),
installation of the certificate (10) at the client terminal (4) by teleloading from the certification organism (9) on request of the installer conditioned on the presentation of the certificate identification and integrating therein the session name of the client taken from the installer.

5. Process according to claim 1 characterized by the fact
that the encryption of the data between the gateway device (5) and the proximity interface device (6) takes place by use of pairs of public and private keys.

6. Process according to claim 1 characterized by the fact
that there is used a proximity interface device (6) in the form of a software extension implemented in the client terminal (4).

7. Process according to claim 3 characterized by the fact
that the client (8) takes his session name in the client terminal (4) during initial configuration of the application of the client terminal (4),
that the identification of the session name taken and of that included in the certificate (10) is verified. to verify the authorization of the client (8).

8. Process according to claim 1 characterized by the fact
that there is used the Telnet 3270 communication protocol.

9. Process according to claim 1 characterized by the fact
that the communications in the system take place by a network of the TCP/IP standard.

10. Computer system with secured communication comprising a server portion (1) provided with at least one server (3) and a client portion (2) provide with at least one client terminal (4) by which a client (10) can access the system by taking a session name, adapted to practice the process according to claim 1, characterized by the fact
that it comprises:
a gateway device (5) in the server portion (1), in communication with the server (3),
a proximity interface device (6) in physical proximity to each client terminal (4), in communication with said client terminal (4) and the gateway device (5),
encryption means for transmissions between the gateway device (5) and the proximity interface device (6).

11. System according to claim 10 characterized by the fact
that the messages of transmission between the gateway device (5) and the proximity interface device (6) comprise a header integrating the security data.
